(19) United States
(12) Patent Application Publication
(10) Pub. No.: US 2022/0191889 A1
(43) Pub. Date: Jun. 16, 2022

(54) METHODS AND SYSTEMS FOR SCHEDULING RANGING AND DATA SESSIONS IN A SHORT-RANGE COMMUNICATION SYSTEM

(71) Applicant: Samsung Electronics Co., Ltd., Gyeonggi-do (KR)

(72) Inventors: Ankur BANSAL, Bangalore (IN); Karthik Srinivasa GOPALAN, Bangalore (IN)

(21) Appl. No.: 17/631,179

(22) PCT Filed: Jul. 31, 2020
(86) PCT No.: PCT/KR2020/010135

§ 371 Date: Jan. 28, 2022

(30) Foreign Application Priority Data
Aug. 2, 2019 (IN) 2019 41031301
Aug. 2, 2019 (IN) 201941031302
Jul. 29, 2020 (IN) 201941031301

(51) Int. Cl. H04W 72/12

(52) U.S. Cl. CPC H04W 72/1242

(57) ABSTRACT

Methods and systems for scheduling ranging sessions in a short-range communication network. A method disclosed herein includes assigning priority for each service of at least one service and dynamically modifying the priority of each service for scheduling ranging and data sessions among user devices for the at least one service. The method further includes forming a group of controllers, creating a group composite schedule information for the group by scheduling the ranging session for each controller of the group, and broadcasting the group composite schedule information to each controller of the group. The group composite schedule information includes information about the scheduled ranging session for each controller of the group.

### TECHNICAL FIELD

The present disclosure relates to the field of short-range communication systems and more particularly to scheduling ranging and data sessions in a short-range communication system.

### BACKGROUND ART

In a short-range communication system, user devices that are located relatively close to each other can communicate with each other without involving any cellular infrastructure. The user devices can communicate with each other over a radio channel supported by one or more short-range communication protocols. Examples of the short-range communication protocols can be, but not limited to, Ultra-Wide Band (UWB), Bluetooth, Bluetooth Low Energy (BLE), Worldwide Interoperability for Microwave Access (WiMAX) or any other IEEE 802.15.4 compliant protocols.

In conventional approaches, the short-range communication system enables the user devices to host one or more applications for providing one or more services in parallel. Examples of the one or more services can be, but not limited to, a gaming service, an access service, a location service, and so on. The user devices can perform radio frequency (RF) ranging and data transfer between each other for performing the one or more services. The RF ranging involves measuring distance/range between the two user devices.

Consider an example scenario as depicted in FIG. 1, wherein a user is initially involved in a gaming session ongoing on a TV/gaming console using a corresponding mobile device. In such a scenario, the mobile device and the TV may perform the RF ranging and the data sessions using one or more allocated resources for the gaming session. Further, consider that the user may move towards a door for unlocking a door lock using the mobile device (i.e. for an access service). In such a scenario, a higher amount of resources compared to the resources allocated for the gaming session has to be provided to the mobile device and the door lock for performing the ranging and the data sessions for the access service, so that a radio channel between the devices can be optimally utilized by enhancing user experience. However, the conventional approaches do not involve assigning priority to the services and dynamically changing the priority to the services.

Further, in the conventional approaches, the one or more user devices may not coordinate with each other for scheduling the ranging sessions for the one or more services. Thus, resulting in contention and backoffs.

Consider an example scenario as depicted in FIG. 2a, wherein the short-range communication system enables 2 mobile devices, 2 gaming consoles/TV, and 3 door locks to perform the ranging sessions among each other for the one or more services in parallel. In such a scenario, 8 RF ranging sessions may occur for the 8 services (i.e., for 2 gaming sessions and 3 door lock sessions). However, out of the 8 RF ranging sessions, 5 ranging sessions may be uncoordinated, as each device does not detect other nearby devices, which is sharing same bandwidth of the system for performing the ranging sessions. The uncoordinated ranging sessions may result in contention with the devices backing off.

Consider an example scenario as depicted in FIGS. 2b-2e, wherein two mobile devices (a mobile device 1, and a mobile device 2), a gaming console (a console 1), two cars (a car 1 and a car 2) may be present in a group 1 and a mobile device (a mobile device 3), a gaming console (a console 2), two cars (a car 1 and a car 2) may be present in a group 2. In the group 1, the mobile device 2 may be a controller and other devices may be controlees. In the group 2, the mobile device 3 may be the controller and the other devices may be controlees. In an example herein consider that, the controller in the group 1 may schedule the ranging sessions for a gaming session 1 among the two mobile devices and the console 1 and a car session 1 between itself and the two cars. The controller in the group 2 may schedule the ranging sessions for a gaming session 2 between itself and the console 2, and a car session 2 between itself and the two cars. However, the scheduled ranging sessions in the group 1 and the group 2 may result in uncoordinated sessions, as the controller 1 and the controller 2 do not coordinate with each other to determine if the devices in the group 1 and the group 2 are using the same bandwidth for performing the ranging sessions.

### DISCLOSURE OF INVENTION

### Technical Problem

The principal object of the embodiments herein is to disclose methods and systems for scheduling ranging and data sessions in a short-range communication system.

Another object of the embodiments herein is to disclose methods and systems for scheduling the ranging and data sessions among a plurality of user devices for at one service based on a priority parameter assigned to each service.

Another object of the embodiments herein is to disclose methods and systems for scheduling coordinated ranging sessions among the plurality of user devices for the at least one service based on group composite scheduling information.

### Solution to Problem

Accordingly, the embodiments herein provide methods and systems for scheduling ranging and data sessions in a short-range communication system. A method disclosed herein includes receiving, by a controller, a request from at least one controlee to schedule at least one session for at least one service of a plurality of services, wherein the at least one session includes at least one of a ranging session and a data session. The method further includes assigning, by the controller, priority parameters to the at least one service for the at least one session. The method further includes scheduling, by the controller, the at least one session among the controller and the at least one controlee for the at least one service, based on the assigned priority parameters.

### BRIEF DESCRIPTION OF DRAWINGS

Embodiments herein are illustrated in the accompanying drawings, throughout which like reference letters indicate corresponding parts in the various figures. The embodiments herein will be better understood from the following description with reference to the drawings, in which:

FIGS. 1, and 2a-2e are example diagrams depicting a conventional method of scheduling ranging session in a short-range communication system;

FIGS. 3a and 3b depict a short-range communication system, according to embodiments as disclosed herein;

FIG. 4 is a block diagram depicting various components of a user device in the short-range communication system, according to embodiments as disclosed herein;

FIG. 5 is a flow diagram depicting a method for scheduling ranging and data sessions based on priority parameters of one or more services, according to embodiments as disclosed herein;

FIG. 6a is an example diagram depicting scheduling of the ranging sessions for the ongoing one or more service by modifying the priority parameters of the ongoing one or more services, according to embodiments as disclosed herein;

FIG. 6b depicts Quality of Service information (QoS IE), according to embodiments as disclosed herein;

FIGS. 7a and 7b depict example use case scenarios of performing the ranging and data sessions for the ongoing services based on the priority parameters of the corresponding services, according to embodiments as disclosed herein;

FIG. 8 is a flow diagram depicting a method for scheduling the ranging session based on group composite scheduling information (GCS IE), according to embodiments as disclosed herein;

FIG. 9a is an example flow diagram depicting a method for creating a group of controllers, according to embodiments as disclosed herein;

FIG. 9b depicts the GCS IE, according to embodiments as disclosed herein;

FIG. 10 is example diagram depicting a method for scheduling of the ranging session based on the GCS IE, according to embodiments as disclosed herein;

FIG. 11 is an example diagram depicting a scenario of scheduling the ranging sessions based on the GCS IE, according to embodiments as disclosed herein; and

FIGS. 12a and 12b are example diagrams depicting the hierarchical scheduling structure defined for the controllers present in the group, according to embodiments as disclosed herein.

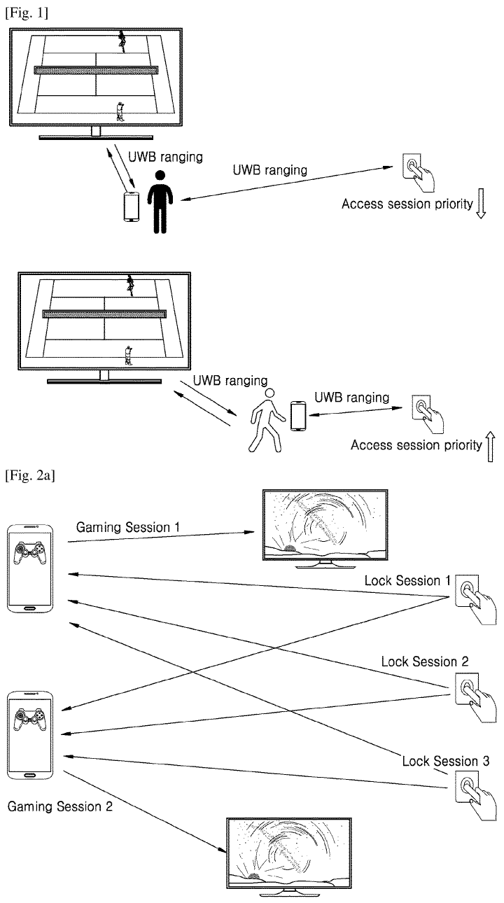

### BEST MODE FOR CARRYING OUT THE INVENTION

Accordingly, the embodiments herein provide methods and systems for scheduling ranging and data sessions in a short-range communication system. A method disclosed herein includes receiving, by a controller, a request from at least one controlee to schedule at least one session for at least one service of a plurality of services, wherein the at least one session includes at least one of a ranging session and a data session. The method further includes assigning, by the controller, priority parameters to the at least one service for the at least one session. The method further includes scheduling, by the controller, the at least one session among the controller and the at least one controlee for the at least one service, based on the assigned priority parameters.

Accordingly, the embodiments herein provide methods and systems for scheduling ranging and data sessions in a short-range communication system. A method disclosed herein includes creating, by a controller, a group of controllers by including at least one other controller. The method further includes determining, by the controller, Quality of Service (QoS) parameters of each of a plurality of services supported by each controller in the group of controllers. The method further includes scheduling, by the controller, the at least one ranging session for each controller in the group of controllers for each of the plurality of services, based on the determined QoS parameters of each service.

Accordingly, embodiments herein provide a short-range communication system comprising at least one controlee and at least one controller coupled with the at least one controlee. The controller is configured to receive a request from the at least one controlee to schedule at least one session for at least one service of a plurality of services, wherein the at least one session includes at least one of a ranging session and a data session. The controller is further configured to assign priority parameters to the at least one service for the at least one session. The controller is further configured to schedule the at least one session among the controller and the at least one controlee for the at least one service, based on the assigned priority parameters.

Accordingly, embodiments herein provide a short-range communication system comprising a plurality of controllers. A controller of is configured to create a group of controllers by including at least one other controller. The controller is further configured to determine Quality of Service (QoS) parameters of each of a plurality of services supported by each controller in the group of controllers. The controller is further configured to schedule at least one ranging session for each controller in the group of controllers for each of the plurality of services, based on the determined QoS parameters of each service.

These and other aspects of the example embodiments herein will be better appreciated and understood when considered in conjunction with the following description and the accompanying drawings. It should be understood, however, that the following descriptions, while indicating example embodiments and numerous specific details thereof, are given by way of illustration and not of limitation. Many changes and modifications may be made within the scope of the example embodiments herein without departing from the spirit thereof, and the example embodiments herein include all such modifications.

### Mode for the Invention

The example embodiments herein and the various features and advantageous details thereof are explained more fully with reference to the non-limiting embodiments that are illustrated in the accompanying drawings and detailed in the following description. Descriptions of well-known components and processing techniques are omitted so as to not unnecessarily obscure the embodiments herein. The description herein is intended merely to facilitate an understanding of ways in which the example embodiments herein can be practiced and to further enable those of skill in the art to practice the example embodiments herein. Accordingly, this disclosure should not be construed as limiting the scope of the example embodiments herein.

Embodiments herein disclose methods and systems for assigning a priority to each of a plurality of services and dynamically changing priority of each service for performing ranging and data sessions in a short-range communication system.

Embodiments herein disclose methods and systems for scheduling coordinated ranging sessions in the short-range communication system.

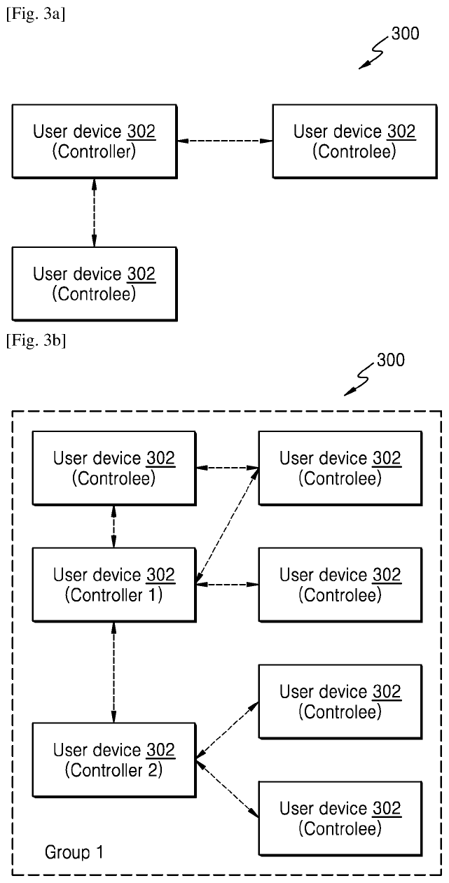

Referring now to the drawings, and more particularly to FIGS. 3a through 12b, where similar reference characters denote corresponding features consistently throughout the figures, there are shown example embodiments.

FIGS. 3a and 3b depict a short-range communication system 300, according to embodiments as disclosed herein. The short-range communication system 300 referred herein can be at least one of, but is not limited to, a wireless sensor network, a smart home/office system, a vehicular safety system, a surveillance system, a health management system, an ambient assistant living system, a gaming system, and so on.

The short-range communication system 300 includes a plurality of user devices 302. The user device 302 can be any device that is capable of using at least one protocol supported by the short-range communication system 300. Examples of the user device 302 can be, but is not limited to, a mobile phone, a smartphone, a tablet, a phablet, a personal digital assistant (PDA), a laptop, a computer, a wearable computing device, a vehicle infotainment device, an Internet of Things (IoT) device, a Virtual Reality (VR) device, a gaming console, a medical device, a home appliance, a vehicle, a Television (TV), a door lock, a media player, a set top box, an auto-guided vehicle, or any other device that is capable of using at least one protocol supported by the short-range communication system 300. Examples of the at least one protocol supported by the short-range communication system 300 can be, but is not limited to, Ultra-Wide Band (UWB), Bluetooth, Bluetooth Low Energy (BLE), Wi-Fi, Infrared wireless communication, Near Field Communication (NFC), Zigbee, Worldwide Interoperability for Microwave Access (WiMAX) or any other IEEE 802.15.4 compliant protocols.

In the short-range communication system 300, the plurality of user devices 302 can be positioned relatively close to each other in a location such as, but not limited to, a home, a room, an office, a hospital, an auditorium, a stadium, a parking space, a floor of a building, a wing in a building, and so on. The plurality of user devices 302 can communicate with each other over a radio channel supported by the at least one protocol of the short-range communication system 300.

The plurality of user devices 302 can further include one or more sensors to monitor at least one user present in the corresponding at least one location. Alternatively, the plurality of user devices 302 can be coupled with the one or more sensors deployed in the corresponding at least one location to monitor the user. Examples of the sensors can be, but not limited to, a camera, a motion sensor, a proximity sensor, a microphone, and so on.

The plurality of user devices 302 can host one or more applications to provide one or more services to at least one user present in the corresponding at least one location. Examples of the one or more services can be, but not limited to, a gaming service, a vehicle ranging service, a banking service, an access service (for example, door unlock service, an appliance unlock service, or the like), a location service, and so on. In an embodiment, each application can be classified into a main application or a secondary application for each user device 302 based on a nature/type of the application. Consider an example scenario, wherein a mobile device (an example of the user device 302) hosts a first application used for a banking service and a second application used for a gaming service.

The plurality of user devices 302 can be configured to execute the one or more applications in parallel to provide the one or more services to the user(s) present in the corresponding location. The user may use any one of the user devices 302 to interact with the one or more services being provided/ongoing on the one or more other user devices 302. In an example, the user can use a mobile device to play a gaming session ongoing on a gaming console. In another example, the user can use the mobile device to unlock a door lock (for example: the access service). In another example, the user can use the mobile device for a vehicle ranging service.

In an embodiment, the user device 302 that executes the application to provide the one or more services can be referred hereinafter as an initiator through the document. In an embodiment, the user device 302 that communicates with the other user device 302 for interacting with the one or more services ongoing on the other user device 302 can be referred hereinafter as a responder through the document.

The user devices 302 (the initiator and the responder) can perform the ranging session and data session for interacting with the ongoing one or more services. The ranging session can be a Radio Frequency (RF) ranging session that involves measuring distance between the two user devices 302. The ranging session can be performed between the two user devices 302 at a time over the radio channel supported by the at least one protocol of the short-range communication system 300. For performing the ranging session, the user device/responder 302 sends a poll message to a known address of the other user device/initiator 302 in time referred as time of sending poll (TSP). On receiving the poll message, the initiator records time of poll reception (TRP) and sends a response message to the responder at time of response poll (TRP). On receiving a response message, the responder records time of receiving response (TRR) and creates a final message, wherein the final message includes an identity (ID) of the responder, the TSP, the TRR, and time of sending final message (TSF). The responder sends the final message to the initiator. On receiving the final message from the responder, the initiator determines time of flight of RF signal and calculates the distance between the initiator and the responder by multiplying the determined time of flight with the speed of light. The data session involves transferring application specific data between the user devices 302.

Embodiments herein enable one of the plurality of user devices 302 to schedule/configure the ranging and data sessions among the plurality of user devices 302 to interact with the ongoing one or more services on each other.

In an embodiment, the ranging sessions and the data sessions can be configured based on priority parameters of the ongoing one or more services. The priority parameters of each service include priority and one or more resources (QoS resources) allocated for each service. Examples of the resources can be, but not limited to, frequency for utilizing the radio channel, bandwidth requirements, acceptable deadline, and so on.

In an embodiment, the ranging sessions can be scheduled by enabling one of the plurality of user devices 302 to perform a composite scheduling method. The composite scheduling method involves forming a group of user devices 302, creating a group composite schedule information for the group by scheduling the ranging session for each user device 302 of the group, and broadcasting the group composite schedule information to each user device 302 of the group. The group composite schedule information includes information about the scheduled ranging session for each user device 302 of the group.

Embodiments herein further explain scheduling the ranging and data sessions for the ongoing one or more services based on the priority parameters of each service.

For scheduling the ranging sessions based on the priority parameters, embodiments herein enable each of the plurality of user devices 302 to act as a controller 302 or a controlee 302 dynamically based on the execution of each of the one or more application for the one or more services. For example, a mobile device (an example of the user device 302) can act as the controller 302, when the mobile device executes its application for providing a banking service. The mobile device can act as the controlee 302, when the mobile device executes its second application for playing a game on a gaming console. For another example, a gaming console (an example of the user device 302) can act as the controller 302, when the gaming console executes an application for providing a gaming service. For another example, a door lock can act as the controller 302, when the door lock executes an application for an access service. Embodiments herein use the terms such as “controller”, “main entity”, “master node”, “primary node”, “node”, and so on interchangeably to refer to a user device 302 that can control the functions of another user devices/controlee. Embodiments herein use the terms such as “controlee”, “slave node”, “secondary node”, and so on interchangeably to refer to a user device that can be controlled by another user device/controller.

The controller 302 can be configured to initially assign the priority parameters to each of the one or more services corresponding to the one or more applications hosted on the controller and the controlee in an initialization phase. The initialization phase can refer to a mode, in which the user devices 302 (including the controller 302 and the one or more controlees) have not started executing the applications for providing the one or more services. The priority parameters of each service include priority and one or more resources allocated for each service. Examples of the resources can be, but not limited to, frequency for utilizing the radio channel, bandwidth requirements, acceptable deadline, and so on. Embodiments herein can use the terms such as “priority parameters”, “QoS parameters”, “priority and resource parameters”, and so on interchangeably to refer to parameters assigned for each service.

For assigning the priority parameters/QoS parameters for each of the one or more services, the controller collects information of the one or more applications (associated with the one or more services) hosted on the controller and the one or more controlees. In an example, the information of the one or more applications can be, but not limited to, a number of services supported by each application, and a nature of each service, and so on.

Based on the collected information of the one or more applications, the controller 302 assigns the priority parameters for each of the one or more services corresponding to the one or more applications hosted on the controller and the one or more controlees. Assigning the priority parameters for each service includes assigning the priority for each service based on the collected information about the nature of the service and assigning the one or more resources for each service based on the assigned priority. The priority can be assigned for each service by assigning weights to each service. Examples of the one or more resources can be, but not limited to, the frequency for utilizing the radio channel, the bandwidth requirements, acceptable deadline, and so on. In an embodiment, the controller 302 can assign two sets of the priority parameters to each service, wherein one set of the priority parameters can be for the ranging session and another set can be for the data session. In an embodiment, the controller 302 can assign the same set of the priority parameters to each service for both the ranging sessions and the data sessions.

For example, the controller 302 can assign the highest priority to a banking service with respect to a gaming service and an access service by assigning higher weights to the banking service compared to the gaming service and the access service. Based on the priority, the controller 302 can assign higher amount of resources for the banking service with respect to the gaming service and the access service. Thus, in this example, the banking service is assigned with the higher priority parameters compared to the gaming service and the access service.

On assigning the priority parameters to each service, the controller creates/generates QoS information (QoS IE). The QoS IE includes information about at least one of, but is not limited to, a number of user devices 302 (the controller and the one or more controlees) present in the at least one location of the system 300, an ID of each user device 302, the priority/QoS parameters of each service that is supported by each user device 302, and so on. The controller 302 stores the QoS IE. Also, the controller 302 broadcasts the created QoS IE to the one or more controlees.

The controller 302 can be further configured to dynamically control/modify the priority parameters of each of the one or more services, on initiating the execution of the one or more applications on the controller 302 and the controlees 302 for providing the one or more services. The controller 302 can schedule the ranging sessions and the data sessions among the controller 302 and the one or more controlees 302 based on the dynamically controlled priority parameters of each of the one or more services.

The controller 302 receives one or more requests from the one or more controlees 302, when the one or more services corresponding to the one or more applications are ongoing on the one or more controlees 302 (i.e., when the controlees 302 start executing the one or more applications corresponding to the one or more services). The one or more requests can be for scheduling the ranging and data sessions for each of the ongoing one or more services. In an embodiment, the one or more controlees 302 may use the QoS IE and extract the current priority parameters of the associated one or more services from the QoS IE. The one or more controlees 302 may include the current priority parameters of the associated one or more services in the one or more requests and send the one or more requests to the controller 302. The current priority parameters of each service may include the initial priority parameters assigned to each service during the initialization phase, or the modified priority parameters for each service during a previous ranging and data session. The controller 302 can also collect the current priority parameters of the one or more services from the stored QoS IE, if the one or more services are ongoing on the controller 302.

On collecting/receiving the current parameters of the one or more services ongoing on the controller 302 and the one or more controlees 302, the controller 302 further determines weights of time delay of a ranging queue and a data queue associated with the one or more services based on context of the one or more services.

The controller 302 further determines user intent. In an embodiment, the user intent can be behavior/actions of the at least one user towards the one or more ongoing services. The at least one user may be present in the corresponding location of the controller 302 and the one or more controlees 302. Examples of the actions can be, but not limited to, movements of the user, gestures performed by the user towards the one or more ongoing services, and so on. In an embodiment, the controller can determine the user intent by collecting data from the sensors, which have been deployed in the corresponding location of the at least one user. In an embodiment, the controller can use a neural network to determine the user intent based on the data collected from the sensors. Examples of the neural network can be, but is not limited to, a convolutional neural network (CNN), a deep neural network (DNN), a recurrent neural network (RNN), a restricted Boltzmann Machine (RBM), a deep belief network (DBN), a bidirectional recurrent deep neural network (BRDNN), generative adversarial networks (GAN), a deep Q-networks, and so on.

The controller 302 modifies the current priority parameters of the ongoing one or more services based on at least one of the determined user intent and the weights of the time delay of the ranging queue and the data queue associated with the one or more services. Modifying the current priority parameters of each ongoing service includes modifying (increasing/decreasing) the current priority of each ongoing service based on the user intent and the weights of the time delay of the queues associated with each service, and modifying (increasing/decreasing) the current one or more resources allocated for each ongoing service based on the modified priority.

The controller 302 assigns the modified current priority parameters as the priority parameters to each ongoing service for the requested ranging and data sessions. The controller 302 further schedules the requested ranging and data sessions among the controller 302 and the one or more controlees for the ongoing one or more services based on the assigned priority parameters for each ongoing service. Thus, the controller 302 and the one or more controlees 302 can perform the ranging sessions and the data sessions based on the dynamically varied priority/QoS parameters of the ongoing one or more services.

The controller 302 updates the stored QoS IE with the modified priority/QoS parameters of the ongoing one or more services. The controller 302 stores the updated QoS IE and broadcasts the updated QoS IE to the one or more controlees 302.

Consider an example scenario, wherein the user is initially using a mobile device (an example of the user device 302) to interact with a gaming session (an example of the user device 302) provided on a gaming console. In such a case, the gaming console can be the controller 302 and the gaming session can be associated with the highest priority/QoS parameters. Further, a door lock (a controlee 302) initiates executing an application for an access service (unlocking the door lock). In such a scenario, the gaming console/controller 302 further collects the current priority parameters of the access service from the door lock/controlee 302 and the priority parameters of the gaming console. Further, the controller 302 determines the user intent. In an example herein, consider that the user intent can be a movement of the user towards the door lock to unlock the door by initiating the application on the mobile device for the access service. Based on the user intent, the received priority parameters of the gaming session and the access service, the controller 302 increases the priority/QoS parameters of the access service and decreases the priority/QoS parameters of the gaming session. Based on the updated priority parameters, the controller 302 may allocate the one or more resources for the mobile device, the gaming console, and the door lock for the gaming session and the access service. The controller 302 updates itself, the door lock, and the mobile device with the updated priority parameters for performing the ranging and data sessions among each other for the access service and the gaming session. Thus, the door lock and the mobile device can perform the ranging and data sessions for the access service with the highest priority parameters to the gaming session.

Embodiments herein further explain scheduling the ranging sessions using the composite schedule method as an example of the scheduling method.

For scheduling the ranging sessions based on the composite schedule information, one of the plurality of user devices 302 that acts as the controller can create a group of controllers by adding the one or more controllers based on positioning of the one or more controllers 302 in the range of location. The controller 302 which creates the group becomes a group owner. Embodiments herein use the terms such as “first controller”, “group owner”, “first node”, and so on interchangeably to refer to a controller who creates the group.

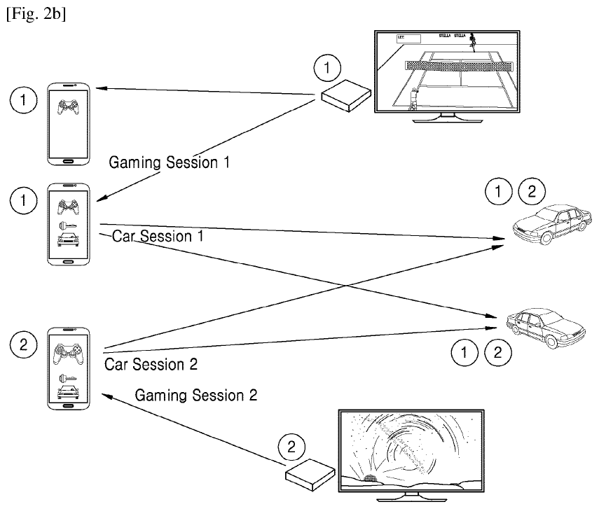

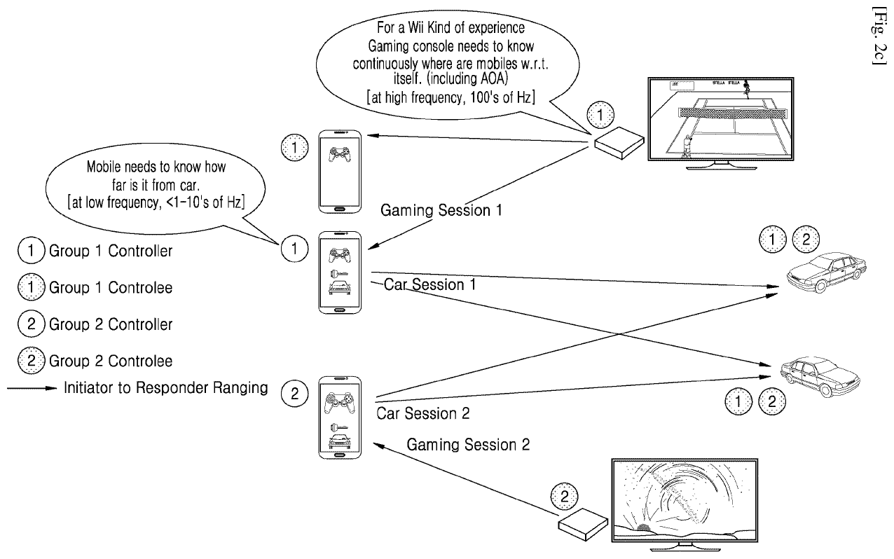

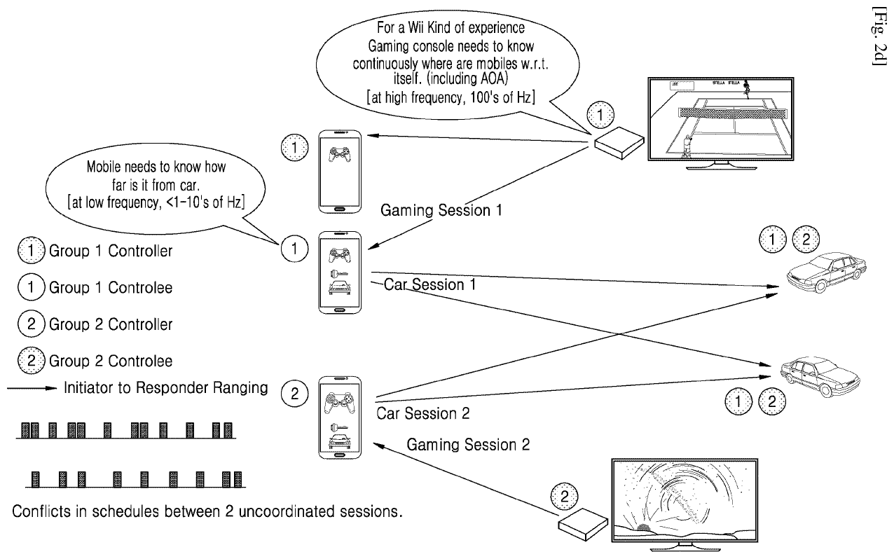

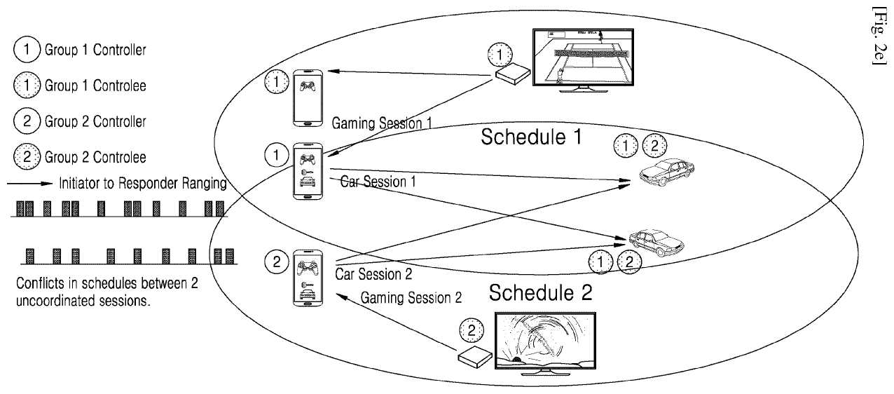

Each controller 302 in the group can be associated with the one or more controlees. For example, as depicted in FIG. 2b, a controller 1 may form a group 1 by adding a controller 2, wherein the controller 1 may be associated with three controlees and the controller 2 may be associated with two controlees.

On forming the group, the group owner 302 (the controller 302 who formed the group) schedules the ranging sessions for each controller in the group of controllers for the one or more services. The one or more services can be supported by the controllers (including the group owner) present in the group. The group owner 302 schedules the ranging sessions by defining one or more slots for each controller. The slot can be ranging round/ranging interval or timing interval in which the ranging sessions can be performed. The group owner can define the slot for each controller based on at least one of, but not limited to, a range of the one or more controllers, the QoS parameters of the one or more services supported by the controllers in the group, and so on.

On scheduling the ranging sessions, the group owner 302 creates group composite schedule information (GCS IE) for the one or more services. The GCS IE include information about the slot defined for each controller to perform the ranging sessions. The GCS IE may include information about at least one of, but not limited to, a controller ID, a number of services correspond to the one or more applications hosted on each user device (the controller/controlees) of the group, service parameters for each service and so on. Examples of the service parameters of each service can be, but is not limited to, expected QoS parameters of each service, the current QoS parameters of each service, the slot/ranging round (including a start and end time), and so on. In an example, the group owner 302 may determine the expected QoS parameters of each service based on service vertical and context of each service.

The group owner 302 checks if the GCS IE has been created successfully for the one or more services. If the GCS IE has not been created successfully for the one or more services, the controller marks the GCS IE as a contention/conflict-based scheduling. If the GCS IE has been created successfully for the one or more services, the controller stores the GCS IE and broadcasts the GCS IE to each controller present in the group. Thus, the controllers present in the group may perform the coordinated ranging sessions.

In an embodiment, the group owner 302 can add the at least one controller 302 to the group as a new controller 302. The new controller 302 can be associated with the one or more controlees. On adding the new controller 302 to the group, the group owner 302 enables the new controller 302 to schedule the ranging sessions for the one or more services supported by the new controller 302. The new controller 302 requests the group owner 302 and receives the GCS IE from the group owner 302. The new controller 302 extracts information from the received GCS IE about the slots/ranging rounds defined for the other controllers. Based on the extracted information from the received GCS IE, the new controller 302 schedules the ranging sessions for the one or more services supported by the new controller 302. The new controller 302 schedules the ranging sessions by defining slots that may not conflict with the slots that have been defined for the other controllers in the group. The new controller 302 updates the received GCS IE by adding the information about the scheduled ranging sessions for the new controller 302 in the received GCS IE. The new controller 302 further stores the updated GCS IE and broadcasts the updated GCS IE to the other controllers (including the group owner) in the group.

If the new controller 302 fails to schedule the ranging sessions by defining the slots that may not conflict with the slots that have been defined for the other controllers in the group, the new controller 302 marks the scheduled ranging sessions as contention-based scheduling sessions.

Alternatively, if the new controller 302 fails to schedule the ranging sessions by defining the slots that may not conflict with the slots that have been defined for the other controllers in the group, the new controller 302 sends a request to the group owner 302 to schedule the ranging sessions for the new controller 302. The request may include the QoS parameters of the one or more services supported by the new controller 302.

On receiving the request from the new controller 302, the group owner 302 performs at least one action based on the received QoS parameters of the one or more services from the new controller and the ranging interval of the group. The ranging interval of the group can be a least common multiple of ranging intervals/ranging rounds of all the ranging sessions ongoing on all the controllers in the group. The performed action can be, but not limited to, assigning an existing empty slot for the new controller, changing a size of the ranging interval of the group to define new slot(s) for the new controller, and so on. The group owner 302 then schedules the ranging sessions for the new controller 302 based on the performed at least one action. The group owner updates the stored GCS IE (i.e., for the controllers present in the group) by adding the information about the scheduled ranging session for the new controller 302 in the stored GCS IE. The group owner 302 stores the updated GCS IE and broadcasts the GCS IE for all the controllers in the group.

If the group owner 302 fails to schedule the ranging sessions for the new controller, the group owner 302 marks the scheduling of the ranging sessions for the new controller as contention-based scheduling sessions.

In an embodiment, the group owner 302 (i.e., the controller which has formed the group) can remove any of the controllers and the associated one or more controlees from the group. In such a case, the group owner 302 updates the stored GCS IE by removing information related to the removed controller from the GCS IE. The group owner stores the updated GCS IE and broadcasts the GCS IE for all the controllers in the group. Thus, the ranging sessions performed in the group using the GCS IE do not conflict/overlap with each other.

FIG. 3 shows exemplary units of the short-range communication system 300, but it is to be understood that other embodiments are not limited thereon. In other embodiments, the short-range communication system 300 may include less or more number of units. Further, the labels or names of the units are used only for illustrative purpose and does not limit the scope of the embodiments herein. One or more units can be combined together to perform same or substantially similar function in the short-range communication system 300.

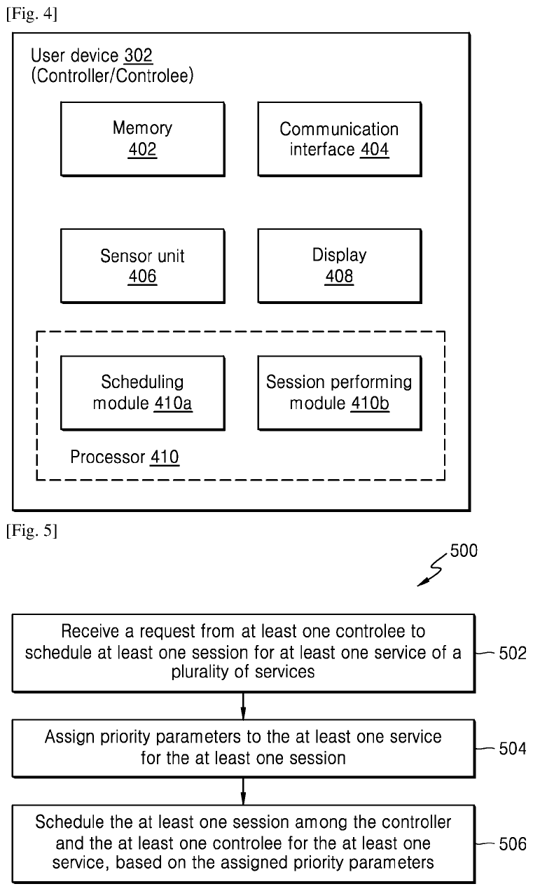

FIG. 4 is a block diagram depicting various components of the user device 302 in the short-range communication system 300, according to embodiments as disclosed herein. The user device 302 can act as the controller 302 and the controlee 302 based on execution of the main/secondary applications to provide the one or more services. The user device 302 includes a memory 402, a communication interface 404, a sensor unit 406, a display 408, and a processor 410. The user device 302 also includes one or more antennas and radio components for communicating with the other user devices 302, a processing circuitry, Input/Output (I/O) ports, and so on (not shown).

The memory 402 stores at least one of, but not limited to, information about the user devices (for example: the ID of each user device, the range/distance between the user devices based on an initial deployment, or the like), the one or more applications, the one or more services supported by each application, the data collected from the sensors, the user intent, the neural network for determining the user intent, the priority parameters, the service parameters, the QoS IE, the GCS IE, and so on. Examples of the memory 402 can be, but not limited to, NAND, embedded Multi Media Card (eMMC), Secure Digital (SD) cards, Universal Serial Bus (USB), Serial Advanced Technology Attachment (SATA), solid-state drive (SSD), and so on. The memory 402 may also include one or more computer-readable storage media. The memory 402 may also include non-volatile storage elements. Examples of such non-volatile storage elements may include magnetic hard discs, optical discs, floppy discs, flash memories, or forms of electrically programmable memories (EPROM) or electrically erasable and programmable (EEPROM) memories. In addition, the memory 402 may, in some examples, be considered a non-transitory storage medium. The term “non-transitory” may indicate that the storage medium is not embodied in a carrier wave or a propagated signal. However, the term “non-transitory” should not be interpreted to mean that the memory 402 is non-movable. In certain examples, a non-transitory storage medium may store data that can, over time, change (e.g., in Random Access Memory (RAM) or cache).

The communication interface 404 can be configured to enable the user device 302 to communicate with the other user devices 302 for the one or more services over the protocol supported by the short-range communication system 300. The communication interface 404 can also enable the user device 302 to communicate with the other user devices over an interface supported by at least one cellular network (for example: Global System for Mobile Communications (GSM), Code-division multiple access (CDMA), Long Term Evolution (LTE)/4G network, New Radio (NR)/5G network, or any other next generation network.

The sensor unit 406 can be configured to sense data about the behavior of the at least one user/actions performed by the user towards the one or more services ongoing on the other user devices 302. The sensor unit 406 includes the sensors such as, but is not limited to, a motion sensor, a proximity sensor, a camera, a microphone, and so on.

The display 408 can be configured to enable the user to interact with the user device 302. The display 408 may provide the one or more services supported by the one or more applications hosted on the user device 302 to the user for interaction.

The processor 410 can be at least one of a single processer, a plurality of processors, multiple homogeneous or heterogeneous cores, multiple Central Processing Units (CPUs) of different kinds, microcontrollers, special media, and other accelerators. The processor 410 may be a general purpose processor, such as a central processing unit (CPU), an application processor (AP), or the like, a graphics-only processing unit such as a graphics processing unit (GPU), a visual processing unit (VPU), and/or an Artificial Intelligence (AI)-dedicated processor such as a neural processing unit (NPU).

The processor 410 can be configured to execute the one or more applications to provide the one or more services to the user. The processor 410 enables the user device 302 to act as the controller or controlee based on the execution of the one or more applications.

The processor 410 can be further configured to perform the ranging and data sessions for the one or more services ongoing on the other one or more user devices 302, when the user device 302 wants to interact with the ongoing one or more services.

The processor 410 can schedule/configure the ranging and data sessions among the plurality of user devices 302 based on the QoS /priority parameters of the ongoing one or more services, when the user device 302 acts as the controller. The processor 410 can perform the ranging and data sessions scheduled by the controller, when the user device 302 acts as the controlee.

The processor 410 can also schedule the ranging sessions among the plurality of user devices 302 for the one or more services by forming the group, creating the GCS IE and broadcasting the GCS IE with the other controllers present in the group, when the user device 302 acts as the controller.

The processor 410 includes a scheduling module 410a and a session performing module 410b. The scheduling module 410a can be enabled to operate, when the user device 302 acts as the controller 302.

In an embodiment, the scheduling module 410a can be configured to schedule the ranging and data sessions among the controller and the one or more controlees (i.e., among the plurality of user devices 302) for the ongoing one or more services based on the QoS/priority parameters of each service. The ongoing one or more services can be the services corresponding to the one or more applications being executed on the controller and the one or more controlees.

Prior to execution of the one or more applications on the controller and the one or more controlees, the scheduling module 401a creates the QoS IE. The QoS IE includes information about, but is not limited to, the number of user devices (the controller and the one or more controlees), the ID of each user device, the one or more applications hosted on each device, the one or more services supported by each application hosted on each user device, the priority/QoS parameters of each service supported by each application hosted on each device, and so on. Examples of the priority/QoS parameters can be, but not limited to, the frequency for utilizing the radio channel, the bandwidth requirements, the priority, the acceptable deadline, and so on.

For creating the QoS IE, the scheduling module 410a communicates with the one or more controlees 302 and collects the ID of the one or more controlees and the information of the one or more applications hosted on the one or more controlees. The scheduling module 410a also fetches the information of the one or more applications hosted on the controller and the ID of the controller from the memory 402. The information of the one or more applications can be, but not limited to, a number of services supported by each application, a nature of each service, requirements of each service, and so on. Based on the information of the one or more applications, the scheduling module 410a assigns the priority parameters for each service for the ranging and the data sessions. In an embodiment, the scheduling module 410 can create the priority parameters for each of the one or more services jointly for both the ranging and data sessions. In such a scenario, the priority parameters for each service include the two sets of priority parameters, wherein one set is for the ranging session and another set is for the data session. In an embodiment, the scheduling module 410a can create the priority parameters for each of the one or more services separately for the ranging and data sessions. In such a scenario, the same priority parameters of each service can be used for both the ranging and data sessions.

For assigning the priority parameters for each service, the scheduling module 410a determines the priority for each service based on the nature of the corresponding service. Assigning the priority involves assigning weights for each service. Based on assigned priority, the scheduling module 410a allocates the resources such as, but not limited to, the frequency for utilizing the channel, the bandwidth requirements, the acceptable deadline, and so on, for each service.

The scheduling module 410a generates the QoS IE by including the device ID of the one or more controlees and the controller, and the priority parameters for each service supported by each of the one or more applications hosted on the controller and the one or more controlees for the ranging and data sessions. On generating the QoS IE, scheduling module 410a broadcasts the QoS IE to the one or more controlees 302. In an embodiment, the scheduling module 410a broadcasts the QoS IE to the one or more controlees 302 over the radio channel supported by the at least protocol of the short-range communication system 300. In an example herein, the scheduling module 410a broadcasts the QoS IE to the one or more controlees 302 through a Bluetooth Personal Area Network (BT PAN). In an example herein, the scheduling module 410a broadcasts the QoS IE to the one or more controlees 302 through the cellular network. The scheduling module 410a also stores the generated QoS IE in the memory 402.

The scheduling module 410a further modifies the QoS/priority parameters of each of the services for scheduling the ranging and data sessions among the controller and the one or more controlees for interacting with the ongoing one or more services. The scheduling module 410a receives one or more requests from the one or more controlees for scheduling the ranging and data sessions, when the one or more controlees 302 initiates executing of the one or more applications to provide the one or more services (i.e., the ongoing one or more services). Also, the scheduling module 410a identifies a request triggered on the controller 302 for scheduling the ranging and data sessions for the ongoing one or more services, when the controller 302 initiates executing of the one or more applications for the corresponding one or more services. The one or more requests may include the current priority parameters of the ongoing one or more services for the ranging sessions and the data sessions.

On receiving the one or more requests, the scheduling module 410a determines the weights of the time delay of the ranging queue and the data queue associated with each of the ongoing one or more services for the ranging sessions and the data sessions based on the context of each service.

The scheduling module 410a further determines the user intent towards the ongoing one or more services for the ranging and data sessions. The user intent can be the behavior of the user/actions performed by the user (of the controller or the one or more controlees) towards the ongoing one or more services.

In an embodiment, the scheduling module 410a determines the user intent based on a sensor based intent detection method. The scheduling module 410a collects the data sensed by the at least one sensor of the sensor unit 406 and determines the user intent.

In an embodiment, the scheduling module 410a determines based on a neural network based intent detection method. The scheduling module 410a feeds the data sensed by the at least one sensor of the sensor unit 406 to the trained neural network, which determines the user intent based on the fed data.

In an embodiment, the neural network can be trained using at least one learning method to determine the user intent based on the data sensed by the at least one sensor. A function associated with the learning method may be performed through the non-volatile memory, the volatile memory, and the processor 410.

The processor 410 may include one or a plurality of processors. At this time, one or a plurality of processors may be a general purpose processor, such as a central processing unit (CPU), an application processor (AP), or the like, a graphics-only processing unit such as a graphics processing unit (GPU), a visual processing unit (VPU), and/or an Artificial Intelligence (AI)-dedicated processor such as a neural processing unit (NPU).

The user intent can be determined in accordance with a predefined operating rule of the neural network stored in the non-volatile memory and the volatile memory. The predefined operating rule of the neural network is provided through training the neural network using the at least one learning method.

Here, being provided through learning means that, by applying the learning method to a plurality of learning data (for example: the data sensed by the sensors), a predefined operating rule or AI model of a desired characteristic is made.

The neural network may comprise of a plurality of neural network layers. Each layer has a plurality of weight values and performs a layer operation through calculation of a previous layer and an operation of a plurality of weights. Examples of the neural network include, but is not limited to, a convolutional neural network (CNN), a deep neural network (DNN), a recurrent neural network (RNN), a restricted Boltzmann Machine (RBM), a deep belief network (DBN), a bidirectional recurrent deep neural network (BRDNN), generative adversarial networks (GAN), and a deep Q-networks.

Based on the determined user intent and the weights of the time delay of the queues associated with each service, the scheduling module 410a modifies the current priority parameters of each of the ongoing one or more services for the ranging and data sessions. Modifying the current priority parameters of each service for the ranging and data sessions include modifying (increasing/decreasing) the current priority of each service based on the user intent and the weights of the time delay of the queues for the ranging and data sessions and modifying (increasing/decreasing) the current resource allocation of each service for the ranging and data sessions based on the modified priority for each service.

In an embodiment, the scheduling module 410a modifies the current priority parameters of each service separately for the ranging and data sessions. In an embodiment, the scheduling module 410a modifies the current priority parameters of each service jointly for both the ranging and data sessions.

Embodiments herein explain modifying the priority parameters of each service by considering the current (initialized or updated) priority parameters of each service for the ranging service and the current (initialized or updated) priority of each service for the data session separately as an example, but it may be obvious to a person skilled in the art that priority of each service can be considered jointly for the ranging service and the data session.

In an example herein, consider that an application 1, an application 2, and an application 3 are ongoing on the one or more controlees 302 and/or the controller 302 to provide a plurality of services (S). Each ongoing service (_) may be associated with the ranging queue and the data queue. In such a scenario, the scheduling module 410a modifies the current priority parameters of each ongoing service for the ranging session and the data session separately.

The scheduling module 410a modifies the current priority (one of the priority parameters) for the ranging session based on the user intent towards each service for the ranging session, the current priority of each service for the ranging session, and the weights of the time delay of the ranging queue associated with each service. In an example herein, the scheduling module 410a modifies the priority of each service using the below equation:

PRi=WRi*Si(PR)*WTDRi

wherein, PRi represents the modified priority of each service for the ranging session, WRi represents the user intent towards each service for the ranging session, Si(PR) represents the current priority of each service for the ranging session, and WTDRi represents the weights of the time delay of the ranging queue associated with each service.

On modifying the priority of each service for the ranging session, the scheduling module 410a modifies the priority of each service for the data session based on the user intent towards each service for the data session, the current priority of each service for the data session and the weights of the time delay of the data queue associated with each service. In an example herein, the scheduling module 410a modifies the priority of each service for the data session using the below equation:

PDi=WDi*Si(PD)*WTDDi

wherein, PDi represents the modified priority of each service for the data session, WDi represents the user intent towards each service for the data session, Si(PD) represents the current priority of each service, and WTDDi represents the weights of time delay of the data queue associated with each service.

On modifying the priority of each service instance for the ranging session and the data session, the scheduling module 410a selects the highest priority of each service among the current priority of each service for the ranging session and the current priority of each service for the data session. Based on the selected highest priority of each service, the scheduling module 410a increases/decreases the weights of the time delay of the ranging queue and the data queue based on the selected queue type for each service instance.

The scheduling module 410a further updates the QoS IE with the modified priority/QoS parameters of each ongoing service. The scheduling module 410a stores the updated QoS IE in the memory 402. The scheduling module 410a broadcasts the QoS IE to the one or more controlees 302. Thus, the controller and the one of the controlees 302 can perform the ranging sessions and the data sessions for the at least one ongoing service (over the radio channel supported by the protocol of the system 300) based on the modified priority parameters of the at least one ongoing service.

In an embodiment, the scheduling module 410a can schedule the ranging sessions based on the GCS IE.

The scheduling module 410a enables the corresponding user device 302 to form the group of controllers, when the user device 302 is the controller 302. The user device/controller 302 which has formed the group becomes the group owner of the group. The group can include the one or more other controllers 302, wherein each controller 302 may be associated with the one or more controlees. The scheduling module 410a enables the controller/the group owner 302 to form the group based on the positioning of the one or more controllers/the associated controlees in the specified range of location. The scheduling module 410a further enables the controller/group owner to add or remove one or more controllers and the associated controlees to/from the group.

On forming the group, the scheduling module 410a of the corresponding controller/the group owner 302 schedules the ranging sessions for each controller (including the group owner) for the one or more sessions. The one or more services can correspond to the one or more applications hosted on the one or more controllers 302 and the associated one or more controlees 302 in the group. The scheduling module 410a schedules the ranging sessions by defining the at least one slot for each of the controllers, so that each controller can schedule the ranging sessions internally among itself and the associated one or more controlees for the one or more services.

In an embodiment, the scheduling module 410a can define the slots based on at least one of, but not limited to, range of the one or more controllers with each other, the QoS parameters of the one or more services corresponding to the one or more applications hosted on the one or more controllers 302 (including the group owner) and the associated one or more controlees 302, and so on. In an embodiment, the scheduling module 410a can define the slots for the controllers 302 of the group in a hierarchical structure. In an example, the slots can be defined for the controllers one after the other. In another example, the slots can be defined for the controllers in a random order.

On scheduling the slots, the scheduling module 410a assigns the service parameters for each of the one or more services. Examples of the service parameters of each service can be, but not limited to, an ID of the service, the expected QoS parameters for each service, the current QoS parameters for each service, the list of ranging rounds (including a start and end time of each ranging session) for each service. The scheduling module 410a then generates the GCS IE for the one or more services. The GCS IE may include information about at least one of, but not limited to, a number of controllers (including the group owner) present in the group, an ID of each controller, a number of services correspond to the one or more applications hosted on each controller of the group and the associated one or more controlees, service parameters of each service, and so on.

From the generated GCS IE, the scheduling module 410a verifies if the defined slots for the one or more controllers 302 (including the group owner) of the group to interact with the one or more services conflict/overlap with each other. If the defined slots for the one or more controllers 302 conflict/overlap with each other, the scheduling module 410a marks the GCS IE as the contention-based scheduling. If the defined slots for the one or more controllers do not conflict/overlap with each other, the scheduling module 410a stores the GCS IE and broadcasts the GCS IE to each controller 302 present in the group of controllers. In an embodiment, the scheduling module 410a broadcasts the GCS IE to each controller 302 present in the group over the radio channel supported by the at least one protocol of the short-range communication system 300. In an embodiment, the scheduling module 410a broadcasts the GCS IE to each controller 302 present in the group through the BT PAN. In an embodiment, the scheduling module 410a broadcasts the GCS IE to each controller 302 present in the group through the cellular network. Thus, the controllers present in the group may perform the coordinated ranging sessions.

In an embodiment, the scheduling module 410a of the controller/group owner 302 may enable a new controller 302 to join the group. The scheduling module 410a shares the GCS IE with the new controller and enables the new controller 302 to schedule the ranging sessions for itself based on the shared GCS IE. The new controller 302 can schedule the ranging sessions that have to be performed among the new controller 302 and the associated one or more controlees for the one or more services. The new controller 302 can schedule the ranging sessions by defining the new slots based on the services parameters of each service supported by the new controller 302 and the received GCS IE. The new controller 302 further verifies if the defined new slots conflict/overlap with the slots defined for the other controllers 302 in the group. If the defined new slots do not conflict/overlap with the slots defined for the other controllers 302 in the group, the new controller 302 assigns the service parameters for the corresponding one or more services. The new controller updates the received GCS IE by adding the service parameters of each service corresponding to the new controller in the GCS IE. The new controller broadcasts the updated GCS IE to all the controllers in the group.

If the defined new slots conflict/overlap with the slots defined for the other controllers in the group, the new controller may request the scheduling module 410a of the group owner 302 to schedule the ranging sessions for the new controller to interact with the corresponding one or more services. The request may include the QoS parameters of the one or more services corresponding to the new controller 302 and the associated one or more controlees.

In an embodiment, on receiving the request from the new controller 302 for scheduling the ranging sessions, the scheduling module 410a of the group owner 302 performs the at least one action based on the received QoS parameters of the one or more services from the new controller, and the ranging interval of the group (the total available time for the group to perform the ranging sessions). In an embodiment, the at least one action can be selecting the empty slot from the slots, which have already been defined for the other controllers 302 in the group and assigning the selected empty slot for the new controller 302. In an embodiment, the at least one action can be changing the size of the ranging interval of the group to define new slot(s) for the new controller 302.

The scheduling module 410a then schedules the ranging sessions for the new controller 302 for the corresponding services based on the performed at least one action. The scheduling module 410a assigns the services parameters for the one or more services corresponding to the new controller based on the scheduled ranging sessions. The scheduling module 410a updates the GCS IE by adding the service parameters of each service corresponding to the new controller in the GCS IE. The scheduling module 410a stores the updated GCS IE in the memory 402 and broadcasts the updated GCS IE to all the controllers in the group.

In an embodiment, the scheduling module 410a (i.e., the controller which has formed the group) can remove any of the controllers and the associated one or more controlees from the group. In such a case, the scheduling module 410a updates the stored GCS IE by removing the QoS parameters of each service corresponding to the removed controller from the GCS IE. The scheduling module 410a stores the updated GCS IE and broadcasts the updated GCS IE for all the controllers in the group. Thus, the ranging sessions performed in the group using the GCS IE do not conflict/overlap with each other.

The session performing module 410b can be configured to enable the user device 302 (controller/controlee) to perform the ranging and data sessions with another user device 302 (controlee/controller) for the at least one ongoing service over the radio channel supported by the at least one protocol of the system 300.

In an embodiment, the session performing module 410b enables the user device 302 to perform the ranging and data sessions based on the QoS IE. When the user device 302 is the controller, the session performing module 410b enables the user device 302 to perform the ranging and data sessions based on the priority parameters for the at least one ongoing service included in the stored QoS IE. When the user device 302 is the controlee, the session performing module 410b enables the user device 302 to perform the ranging and data sessions, on receiving the assigned/modified priority parameters for the at least one ongoing service in the QoS IE from the controller, when the user device 302 is the controlee.

In an embodiment, the session performing module 410b enables the user device 302 (the controller) to perform the ranging sessions based on the GCS IE. The session performing module 410b extracts information about the at least one slot defined for the user device 302 from the GCS IE and enables the user device 302 to perform the ranging sessions within the defined at least one slot.

FIG. 4 shows exemplary units of the user device 302 (the controller or the controlee), but it is to be understood that other embodiments are not limited thereon. In other embodiments, the user device 302 may include less or more number of units. Further, the labels or names of the units are used only for illustrative purpose and does not limit the scope of the embodiments herein. One or more units can be combined together to perform same or substantially similar function in the user device 302.

FIG. 5 is a flow diagram depicting a method for scheduling the ranging sessions based on the priority parameters of the one or more services, according to embodiments as disclosed herein.

At step 502, the method includes receiving, by the controller, a request from the at least one controlee 302 to schedule the at least one session for the at least one service, wherein the at least one session includes at least one of the ranging session and the data session.

At step 504, the method includes assigning, by the controller 302, the priority parameters to the at least one service for the at least one session. At step 506, the method includes scheduling, by the controller 302, the at least one session among the controller 302 and the at least one controlee 302 for the at least one service, based on the assigned priority parameters. The various actions in method 500 may be performed in the order presented, in a different order or simultaneously. Further, in some embodiments, some actions listed in FIG. 5 may be omitted.

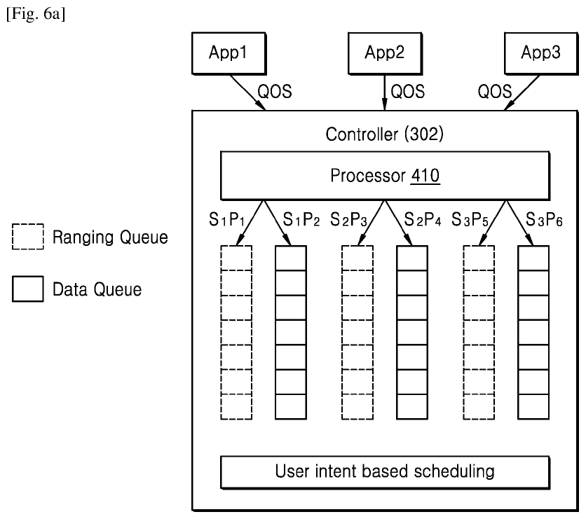

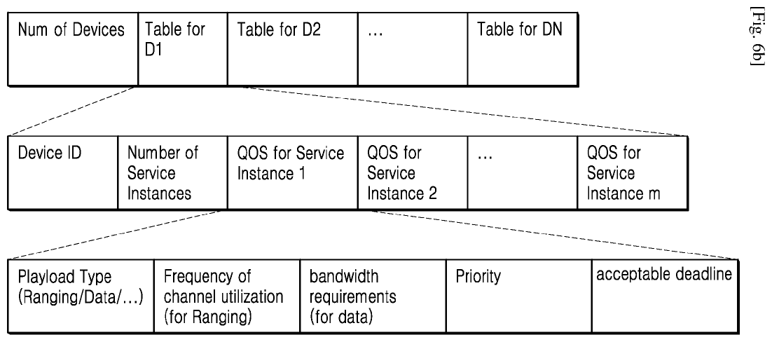

FIG. 6a is an example diagram depicting scheduling of the ranging sessions for the ongoing one or more service by modifying the priority parameters of the ongoing one or more services, according to embodiments as disclosed herein.

Consider an example scenario, wherein the controlees 302 initiate executing an application 1 (app1), an application 2 (app2), and an application 3 (app3) to provide a service 1 (S1), a service 2 (S2), and a service 3 (S3) respectively. Each service may be associated with the ranging queue and the data queue. When the S1, the S2, and the S3 are ongoing on the controlees 302, the controlees send requests to the controller 302 to schedule the ranging and data sessions among the controller 302 and/or the controlees 302 to interact with the ongoing services S1-S3. The controlees access the stored QoS IE and extracts the current priority parameters for the corresponding ongoing services S1-S3. As depicted in FIG. 6b, the QoS IE includes at least one of, but is not limited to, a number of user devices 302 (the controller and the one or more controlees), a table for each device, and so on. The table for each device includes information about, but not limited to, the ID of each user device 302, a number of services corresponding to the one or more applications hosted on each user device 302, the QoS/priority parameters of each user device 302, and so on. The QoS/priority parameters of each user device 302 may include at least one of the priority of each service for the ranging session and the data session, the resources allocated for each service for the ranging session and the data session.

The controlees 302 include the extracted current priority parameters of the corresponding services S1-S3 in the requests and send the requests to the controller 302.

On receiving the requests for scheduling the ranging and data sessions, the controller 302 determines the user intent for performing the ranging session or the data session towards the services S1-S3. The controller 302 may determine the user intent by collecting the sensor data or using the neural network. The controller 302 also determines the weights of the delay time of the ranging queue and the data queue as-sociated with the services S1-S3.

The controller 302 modifies the priority parameters of the services S1-S3 for the ranging sessions based on the current priority of the services S1-S3 for the ranging sessions, the user intent determined for the services S1-S3 for the ranging sessions, and the weights of the delay time of the ranging queue associated with the services S1-S3. Similarly, the controller 302 modifies the priority parameters of the services S1-S3 for the data sessions based on the current priority of the services S1-S3 for the data sessions, the user intent determined for the services S1-S3 for the data sessions, and the weights of the delay time of the data queue associated with the services S1-S3. Modifying the priority parameters of the services may involve increasing or decreasing the priority parameters of the services S1-S3.

The controller 302 broadcasts the modified priority parameters of the ongoing services S1-S3 to the respective controlees 302. Thus, the controller 302 and the controlees 302 can perform the ranging and data sessions according to modified priority parameters.

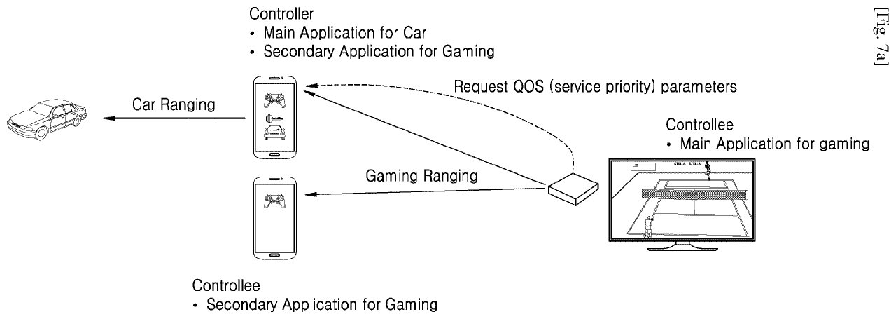

FIGS. 7a and 7b depict example use case scenarios of performing the ranging and data sessions for the ongoing services based on the QoS/priority parameters of the corresponding services, according to embodiments as disclosed herein.

Consider an example scenario as depicted in FIG. 7a, wherein user executes an application on a mobile device (an example of the user device 302) to perform an example service of car distance ranging service. In such a case, the mobile device 302 acts as the controller and a car acts as a controlee, as the application is being executing on the mobile device 302 to perform the car distance ranging is the main application for the mobile device 302. Further, the mobile device/controller 302 assigns highest priority for the car distance ranging and allocates the resources based on the assigned priority for the car distance ranging. Thus, the mobile device/controller 302 and the car/controlee 302 perform the ranging session and the data session for the car distance ranging using the allocated resources and the assigned priority. Subsequently, a gaming console (an example of the user device 302) initiates execution of an application to provide a gaming session. On initiating the execution of the application, the gaming console 302 sends a request to the mobile device/controller 302 for scheduling the ranging session and the data session for the gaming session. The request includes the current priority and allocated resources to the gaming session.

On receiving the request for scheduling the ranging session and the data session, the mobile device/controller 302 determines the current priority of the gaming service and the user intent towards the gaming service. In an example herein, consider that the user intent can be an input/gesture received by the mobile device/controller 302 to execute the application for the gaming session. Based on the determined current priority of the gaming session and the user intent, the mobile device/controller 302 increases the priority of the gaming session by decreasing the priority of the car distance ranging service. On increasing the priority of the gaming session, the mobile device/controller 302 increases the allocation of the resources for the gaming session by decreasing the allocation of the resources for the car distance ranging service. In an example, increasing the allocation of resources involves increasing the frequency/time for utilizing the radio channel, increasing the bandwidth requirements, and so on.

The mobile device/controller 302 communicates the modified QoS/priority parameters to the gaming console/controlee 302 for performing the ranging session and the data session for the gaming session. The modified QoS/priority parameters include information about the increased priority of the gaming session and the increased allocation of the resources for the gaming session.

Further, when the user executes the application for the gaming session on the mobile device 302, the mobile device 302 acts as the controlee and the gaming console 302 acts as the controller, since the application that supports the gaming session is the main application for the gaming console and the secondary application for the mobile device. The gaming console/controller 302 and the mobile device/controlee 302 can perform the ranging session and the data session for the gaming session using the modified QoS/priority parameters of the gaming session.

Consider an example scenario as depicted in FIG. 7b, wherein a door lock (an example of the user device 302) executes an application for the access service (i.e., to unlock the door) and the user uses a mobile device (an example of the user device 302) to interact with the access service ongoing on the door lock. In such a scenario, the door lock 302 acts as the controller and the mobile device 302 acts as the controlee, as the application that supports the access service is the main application for the door lock 302 and the secondary application for the mobile device 302. Further, the door lock/controller 302 assigns the highest priority for the access service and allocates the resources based on the assigned priority for the access service. Thereafter, the mobile device 302 and the door lock 302 perform the ranging session and the data session for the access service using the allocated resources based on the priority of the access service. Subsequently, the user initiates execution of the application for the car distance ranging on the mobile device/controlee 302. In such a scenario, the mobile device/controlee 302 sends a request to the door lock/controlee for performing the ranging session and the data session for the car distance ranging service. The request includes the current priority/QoS parameters (the priority and the allocated resources) of the car distance ranging service.

On receiving the request for scheduling the ranging and data sessions, the door lock/controller 302 determines the current priority of the car distance ranging service and the user intent towards the car distance ranging service. In an example herein, consider that the user intent can be a movement of the user towards a car. Based on the determined current priority of the car distance ranging service and the user intent, the door lock/controller 302 increases the priority of the car distance ranging service by decreasing the priority of the access service. On increasing the priority of the car distance ranging service, the door lock/controller 302 increases the allocation of the resources for the car distance ranging service by decreasing the allocation of the resources for the car distance ranging service. The door lock/controller 302 communicates the modified QoS/priority parameters to the mobile device/controlee 302 for performing the ranging session and the data session for the car distance ranging service. The modified QoS/priority parameters include information about the increased priority of the car distance ranging service and the increased allocation of the resources for the car distance ranging service.

Further, when the car distance ranging service is ongoing on the mobile device 302, the mobile device 302 acts as the controller and the door lock 302 and the car 302 acts as the controlees, since the application for the car distance ranging service is the main application for the mobile device 302. The mobile device/controller 302 and the car/controlee 302 perform the ranging session and the data session for the car distance ranging service using the modified QoS/priority parameters of the car distance ranging service.

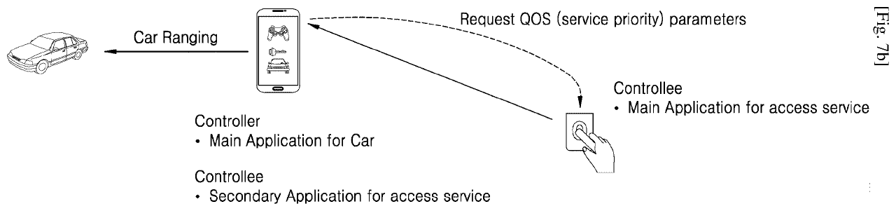

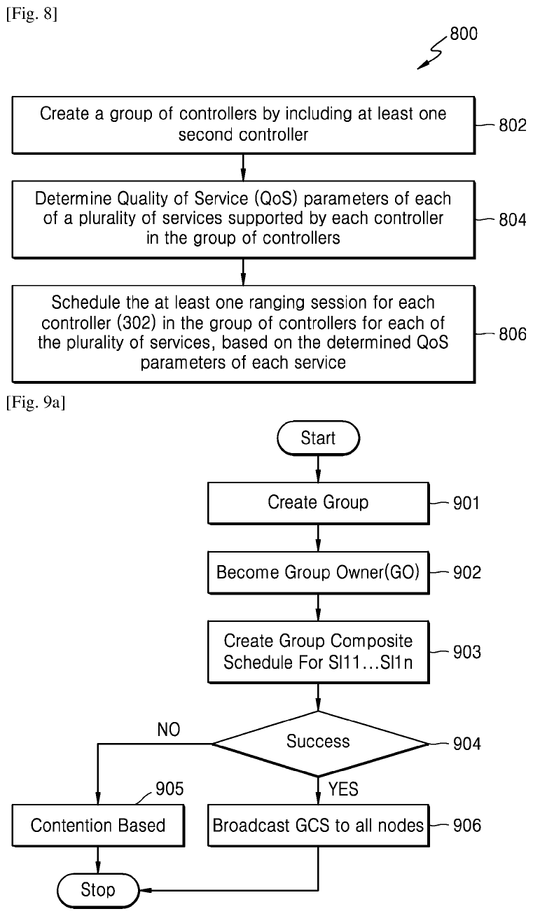

FIG. 8 is a flow diagram 800 depicting a method for scheduling the ranging session based on the GCS IE, according to embodiments as disclosed herein.

At step 802, the method includes creating, by the controller 302/group owner, a group of controllers by including at least one other controller 302.

At step 804, the method includes determining, by the controller 302, the QoS parameters of each of the plurality of services supported by each controller 302 present in the group of controllers.

At step 806, the method includes scheduling, by the controller 302, the at least one ranging session for each controller 302 in the group of controllers for each of the plurality of services, based on the determined QoS parameters of each service. The controller 302 further creates the GCS IE based on the scheduled at least one ranging session for each controller 302 in the group of controllers. The controller 302 broadcasts the created GCS IE to each controller in the group of controllers to perform the scheduled at least one ranging session for at least one of the plurality of services. The various actions in method 800 may be performed in the order presented, in a different order or simultaneously. Further, in some embodiments, some actions listed in FIG. 8 may be omitted.

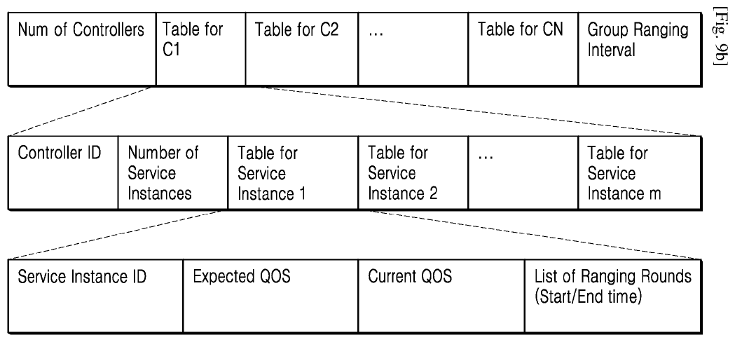

FIG. 9a is an example flow diagram depicting a method for creating the group of controllers, according to embodiments as disclosed herein.

At step 901, one of the plurality of user devices 302 that acts as the controller 302 can create the group of controllers by adding the one or more controllers positioned in the specific range of location/area. Each controller in the group may be associated with the one or more controlees. At step 902, the controller 302, which has created the group may become the group owner of the group.

At step 903, the group owner 302 creates the GCS IE, which can be used to schedule the ranging sessions for the one or more services (for example: S11, S12 . . . S1n). The one or more services can be the services supported by the one or more applications hosted on the nodes (the one or more controllers and the one or more controlees) of the group. The group owner 302 schedules the ranging sessions by allocating the at least one slot for each of the controllers (including the group owner) present in the group. On allocating the slots, the group owner 302 creates the service parameters for each of the one or more services. Examples of the service parameters of each service can be, but not limited to, the ID of each service, the current QoS parameters of each service, the expected QoS parameters of each service, the list of ranging rounds for each service (including information about the start and end time of each ranging session), and so on. The group owner generates the GCS IE based on the created service parameters of the one or more services. As depicted in FIG. 9b, the GCS IE includes information about at least one of, but not limited to, a number of controllers present in the group, a table for each group, and so on. The table for each controller includes information about the ID of each controller, the number of services associated with each controller, the service parameters of each service associated with each controller, and so on.

At step 904, the group owner checks if the creation of the GCS IE is successful. If the generation of the GCS IE is unsuccessful, at step 905, the group owner marks the scheduled ranging sessions as the contention based ranging sessions.

If the generation of the GCS IE is successful, at step 906, the group owner broadcasts the generated GCS IE to all the controllers present in the group. The various actions in method may be performed in the order presented, in a different order or simultaneously. Further, in some embodiments, some actions listed in FIG. 9a may be omitted.

FIG. 10 is example diagram depicting a method for scheduling of the ranging session based on the GCS IE, according to embodiments as disclosed herein.

At step 1001, the one of the plurality user devices 302 that act as the controller joins to the group as the new controller. At step 1002, the new controller 302 receives the GCS IE from the group owner 302. The GCS IE may include information about the scheduled slots for the other controllers (including the group owner) to perform the ranging sessions.

At step 1003, the new controller 302 schedules the ranging sessions for itself for the one or more services (S21 . . . S2n), based on the received GCS IE from the group owner 302. The one or more services (S21 . . . S2n) can be the services corresponding to the applications hosted on the new controller 302 and the associated one or more new controlees 302. The new controller 302 extracts the information about the slots/ranging rounds defined for the controllers and the group owner included in the group. The new controller302 schedules the ranging session by defining new slots for itself based on the slots that have already defined for the controllers and the QoS parameters of the services supported by the new controller 302. The new controller 302 then updates the received GCS IE by adding the information of the scheduled ranging sessions for the new controller in the received GCS IE.

At step 1004, the new controller 302 checks if scheduling of the ranging sessions for the one or more services supported by the new controller 302 is successful. If scheduling of the ranging sessions for the one or more services supported by the new controller 302 is successful, at step 1005, the new controller broadcasts the updated GCS IE to all the controllers 302 and the group owner 302 in the group.

If scheduling of the ranging sessions for the one or more services supported by the new controller 302 is unsuccessful, at step 1006, the new controller 302 marks the scheduled ranging sessions for the new controller 302 as the contention-based scheduling.

Alternatively, if scheduling of the ranging sessions for the one or more services supported by the new controller 302 is unsuccessful, at step 1007, the new controller 302 requests the group owner 302 to schedule the ranging sessions for the new controller 302. The new controller 302 sends the QoS parameters of the one or more services supported by the new controller to the group owner 302.

At step 1008, the group owner 302 schedules the ranging sessions for the new controller by defining the new slots for the new controller. In an embodiment, the group owner 302 checks for the existing empty slots from the GCS IE and defines the existing empty slots for the new controller 302. In an embodiment, the group owner 302 changes the size of the ranging interval of the group to create the new slots and defined the new slots for the new controller 302. The group owner 302 updates the GCS IE by adding the information of the information of the scheduled ranging sessions for the one or more services associated with the new controller in the stored GCS IE.

At step 1009, the group owner 302 checks if scheduling of the ranging sessions for the one or more services supported by the new controller 302 is successful. If scheduling of the ranging sessions for the one or more services supported by the new controller 302 is successful, at step 1010, the group owner 302 broadcasts the updated GCS IE to all the controllers 302 (including the new controller 302) in the group.

If scheduling of the ranging sessions for the one or more services supported by the new controller 302 is unsuccessful, at step 1011, the group owner 302 marks the scheduled ranging sessions for the new controller 302 as the contention-based scheduling. The various actions in method may be performed in the order presented, in a different order or simultaneously. Further, in some embodiments, some actions listed in FIG. 10 may be omitted.

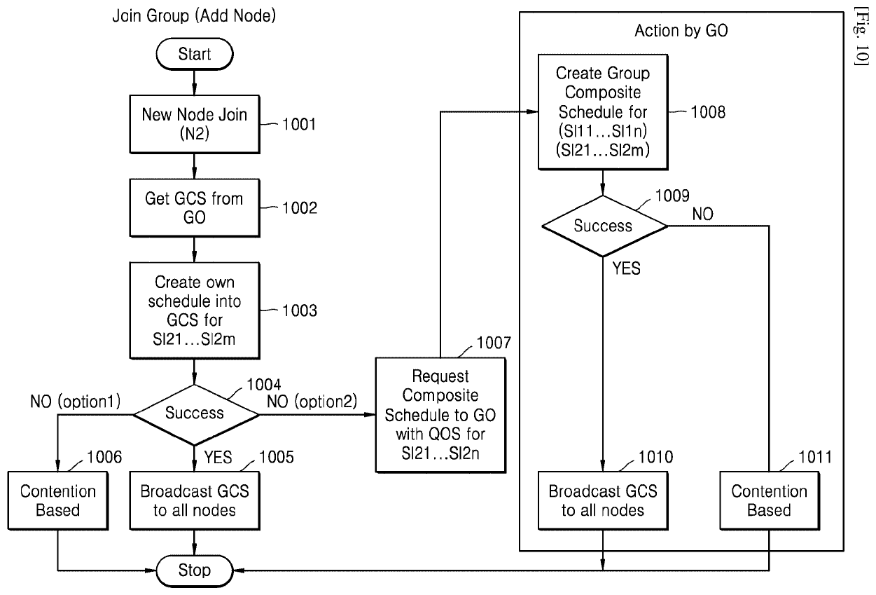

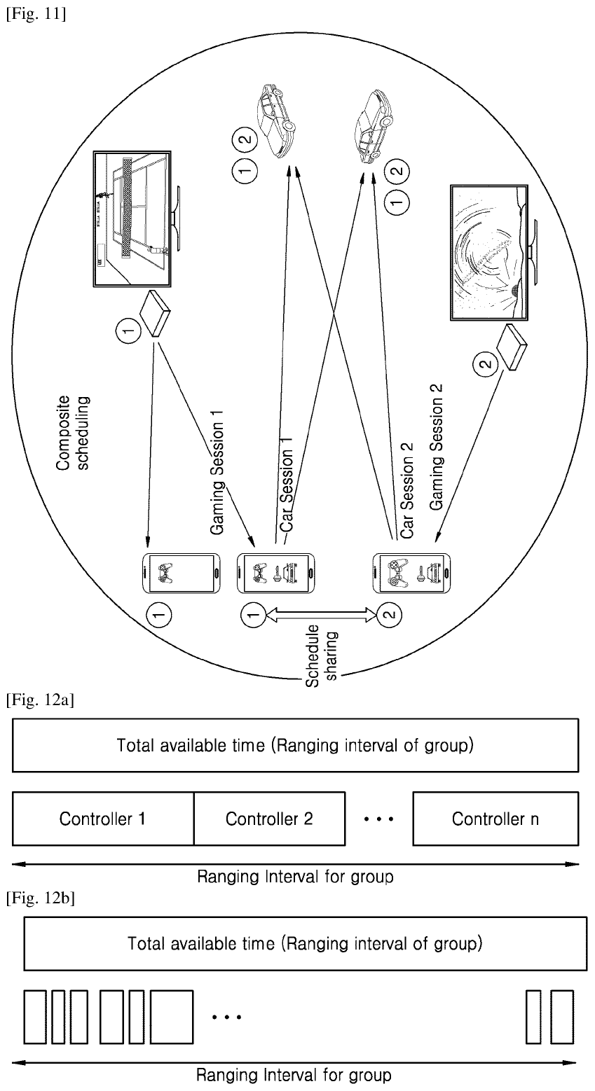

FIG. 11 is an example diagram depicting a scenario of scheduling the ranging sessions based on the GCS IE, according to embodiments as disclosed herein.

Consider an example scenario, wherein a user device/mobile device 302 that is being acting as the controller (a controller 1) forms the group based on the user devices 302 present in the specific range of location. The controller 1 which formed the group becomes the group owner of the group. The user devices 302 present in the group can include three controlees ((a controlee 1 (mobile device), a controlee 2 (gaming console), and a controlee 3 (car)) associated with the controller 1, a controller 2 (mobile device) and two controlees associated with the controller 2 (a controlee 4 (gaming console), and a controlee 5 (car)).

On forming the group, the controller 1 schedules the ranging sessions by defining the slots/ranging slots for the one or more services. In an example herein, the one or more services can be at least one of, but not limited to, a gaming session 1, a gaming session 2, a car session 1, a car session 2, and so on. The gaming session 1 and the car session 1 can be associated with the controller 1. The gaming session 2 and the car session 2 can be associated with the controller 2. The controller 1 schedules the ranging sessions by defining slots for the controller 1 and the controller 2. The controller 1 generates the GCS IE by including information about the scheduled ranging sessions for the controller 1 and the controller 2 in the group.

The controller 1 shares the generated GCS IE with the controller 2. The controller 1 schedules the ranging sessions internally among the controller 1 and the associated three controlees by extracting the information about the slot defined for the controller 1 from the GCS IE. The controller 2 schedules the ranging sessions internally among the controller 2 and the associated two controlees by extracting the information about the slot defined for the controller 2 from the GCS IE. Thus, one to multiple ranging sessions can be performed in the group without any conflicts/overlap.

FIGS. 12a and 12b are example diagrams depicting the hierarchical scheduling structure defined for the controllers present in the group, according to embodiments as disclosed herein.

Embodiments herein generate the GCS IE for scheduling the ranging sessions for the one or more services in the group. The GCS IE may include information about the slots/ranging rounds scheduled for each controller of the group. Each controller may schedule the ranging sessions among the controller and the one or more controlees for the one or more services internally within the defined at least one slot. In an embodiment, the at least one slot can be defined for each controller 302 in the hierarchical structure. In an example as depicted in FIG. 12a, the slots can be defined for the controllers one after the other. In another example, the slots can be defined for the controllers in a random order as depicted in FIG. 12b.

The embodiments disclosed herein can be implemented through at least one software program running on at least one hardware device and performing network management functions to control the elements. The elements shown in FIGS. 3a, 3b, and 4, can be at least one of a hardware device, or a combination of hardware device and software module.

The embodiments disclosed herein describe methods and systems for scheduling ranging sessions in a short-range communication system. Therefore, it is understood that the scope of the protection is extended to such a program and in addition to a computer readable means having a message therein, such computer readable storage means contain program code means for implementation of one or more steps of the method, when the program runs on a server or mobile device or any suitable programmable device. The method is implemented in a preferred embodiment through or together with a software program written in e.g. Very high speed integrated circuit Hardware Description Language (VHDL) another programming language, or implemented by one or more VHDL or several software modules being executed on at least one hardware device. The hardware device can be any kind of portable device that can be programmed. The device may also include means which could be e.g. hardware means like e.g. an ASIC, or a combination of hardware and software means, e.g. an ASIC and an FPGA, or at least one microprocessor and at least one memory with software modules located therein. The method embodiments described herein could be implemented partly in hardware and partly in software. Alternatively, the invention may be implemented on different hardware devices, e.g. using a plurality of CPUs.

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of embodiments, those skilled in the art will recognize that the embodiments herein can be practiced with modification within the spirit and scope of the embodiments as described herein.

1. A method for scheduling sessions in a short-range communication system, the method comprising:
receiving, by a controller, a request from at least one controlee to schedule at least one session for at least one service of a plurality of services, wherein the at least one session includes at least one of a ranging session and a data session;
assigning, by the controller, priority parameters to the at least one service for the at least one session; and
scheduling, by the controller, the at least one session among the controller and the at least one controlee for the at least one service, based on the assigned priority parameters.

2. The method of claim 1, wherein the priority parameters include at least one of priority, and Quality of Service(QoS) resources, wherein the QoS resources include at least one of, frequency for utilizing a radio channel, bandwidth requirements and an acceptable deadline.

3. The method of claim 1, wherein assigning, by the controller, the priority parameters to the at least one service for the at least one session includes:
receiving current priority parameters of the at least one service from the at least one controlee, wherein the current priority parameters of the at least one service include one of initial priority parameters of the at least one service and updated priority parameters of the at least one service during at least one previous session;
determining weights of time delay of at least one queue associated with the at least one service for the at least one session, wherein the at least one queue includes at least one of a ranging queue and a data queue;
determining user intent towards the at least one service for the at least one session;
modifying the current priority parameters of the at least one service based on the determined weights of the time delay of the at least one queue and the user intent towards the at least one service for the at least one session; and
assigning the modified priority parameters as the priority parameters to the at least one service for the at least one session.

4. The method of claim 3, wherein the current priority parameters of the at least one service are included in the QoS information(QoS IE) stored on the at least one controlee.

5. The method of claim 4, wherein the QoS IE includes information about at least one of, a number of user devices, an identifier(ID) of each user device, a number of services supported by each user device, and the priority parameters of each service supported by each device, wherein the user devices include at least one of the controller and the at least one controlee.

6. The method of claim 5, wherein the QoS IE is generated by the controller, in an initialization phase by:
collecting information of a plurality of applications hosted on the controller and the at least one controlee to support the plurality of services, wherein the information of the plurality of applications includes at least one of, a number of services supported by each application, and a nature of each service;
assigning the initial priority parameters for each of the plurality of services based on the collected information related to the nature of each service;
generating the QoS IE based on the assigned initial priority parameters for each of the plurality of services for the at least one session; and
broadcasting the generated QoS IE to the at least one controlee and storing the generated QoS IE in a memory.

7. The method of claim 6, wherein assigning the initial priority parameters for each service includes:
determining an initial priority for each of the plurality of services for the at least one session based on the collected information related to the nature of each service; and
allocating initial QoS resources for each of the plurality of services for the at least one session based on the determined initial priority for each service.

8. The method of claim 3, wherein the user intent is determined using one of a sensor based intent detection method and a neural network based intent detection method.

9. The method of claim 3, wherein modifying the current priority parameters of the at least one service includes:
modifying current priority of the at least one service for the at least one session based on the determined weights of the time delay of the at least one queue and the user intent towards the at least one session for the at least one session; and
modifying current QoS resources of the at least one service for the at least one session based on the modified priority of the at least one service.

10. The method of claim 3, further comprising:
updating the QoS IE with the modified priority parameters of the at least one service for the at least one session; and
broadcasting the updated QoS IE to the at least one controlee and storing the updated QoS IE in the memory.

11. A short-range communication system comprising:
at least one controlee; and
at least one controller coupled with the at least one controlee, wherein a controller is configured to:
receive a request from the at least one controlee to schedule at least one session for at least one service of a plurality of services, wherein the at least one session includes at least one of a ranging session and a data session;
assign priority parameters to the at least one service for the at least one session; and
schedule the at least one session among the controller and the at least one controlee for the at least one service, based on the assigned priority parameters.

12. A method for scheduling at least one ranging session in a short-range communication system, the method comprising:
creating, by a controller, a group of controllers by including at least one other controller;
determining, by the controller, Quality of Service(QoS) parameters of each of a plurality of services supported by each controller in the group of controllers; and
scheduling, by the controller, the at least one ranging session for each controller in the group of controllers for each of the plurality of services, based on the determined QoS parameters of each service.

13. The method of claim 12, further comprising:
creating, by the controller, group composite schedule information(GCS IE) based on the scheduled at least one ranging session for each controller in the group of controllers; and
broadcasting, by the controller, the created GCS IE to each controller in the group of controllers to perform the scheduled at least one ranging session for at least one of the plurality of services.

14. The method of claim 12, further comprising:
adding, by the controller, at least one new controller to the created group of controllers; and
enabling, by the controller, the at least one new controller to schedule the at least one ranging session for the at least one service supported by the at least one new controller,
wherein scheduling, by the at least one new controller, the at least one ranging session for the at least one service includes:
receiving the GCS IE from the controller;
extracting the information about the at least one slot defined for each controller in the group of controllers; and
scheduling the at least one ranging session by defining at least one new slot for the at least one new controller based on the extracted information and the QoS parameters of the at least one service supported by the at least one new controller.

15. A short-range communication system comprising:
a plurality of controllers, wherein a controller of the plurality of controllers is configured to:
create a group of controllers by including at least one other controller;
determine Quality of Service(QoS) parameters of each of a plurality of services supported by each controller in the group of controllers; and
schedule at least one ranging session for each controller in the group of controllers for each of the plurality of services, based on the determined QoS parameters of each service.
